(19) United States
(12) Patent Application Publication
(10) Pub. No.: US 2004/0019552 A1
(43) Pub. Date: Jan. 29, 2004

(54) Limited inventory offered for sale at iteratively adjusted pricing

(76) Inventor: Christopher M. Tobin, McLean, VA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/978,967

(22) Filed: Oct. 15, 2001

Related U.S. Application Data
(60) Provisional application No. 60/254,183, filed on Dec. 7, 2000.

(51) Int. Cl. G06F 17/60

(52) U.S. Cl. 705/37

(57) ABSTRACT

Limited inventory is offered for sale at iteratively adjusted pricing. An item of an inventory is offered for sale to a consumer at a current sale price in a network-enabled auction. The current sale price for the item is iteratively adjusted based upon pre-defined criteria, such as an amount of inventory remaining or an elapsed time that the item has been offered. A bid on the item is received from the consumer at the current sale price.

### RELATED APPLICATIONS

This application claims the benefit of U.S. Provisional Application Serial No. 60/254,183 filed on Dec. 7, 2000. The provisional application is hereby incorporated by reference into the present application.

### FIELD OF THE INVENTION

The field of the invention relates to network-based auctions generally and to iteratively adjusted auction pricing in particular.

### BACKGROUND

For several years, “auctions” have been carried out over the Internet. These auctions are generally of two types. A standard auction is one in which multiple buyers bid competitively for products from individual suppliers. A “reverse auction” is one in which a buyer posts his need for a good or service, then suppliers bid to fulfill the need.

In either case, the buyer makes his bid on the product without knowing in advance whether it will be accepted. In addition, especially in the case of reverse auctions, the buyer may not even know exactly what he will receive in return for his bid. For example, when a bid is made by a buyer on a hotel room in a reverse auction scheme, sellers will respond with offers of hotel rooms in hotels of the type and location loosely matching the broad parameters set by the buyer. The auction service provider may then compel the buyer to accept and pay for the product offered at the lowest price, even though the location of the hotel might be inconvenient to the buyer or the hotel may be of a chain that the buyer dislikes.

There is currently no auction by which the buyer can bid on a item, with the advance knowledge of a detailed description of the item and of the fact that his bid will be accepted. Additionally, there is no auction whereby the price of a known product being auctioned is iteratively adjusted until the inventory is exhausted.

### SUMMARY

Limited inventory is offered for sale at iteratively adjusted pricing. An item of an inventory is offered for sale to a consumer at a current sale price in a network-enabled auction. The current sale price for the item is iteratively adjusted based upon pre-defined criteria, such as an amount of inventory remaining or an elapsed time that the item has been offered. A bid on the item is received from the consumer at the current sale price.

### BRIEF DESCRIPTION OF THE DRAWINGS

FIG. 1 is a flow diagram of one embodiment of a network-enabled auction method.

FIG. 2 is a flow diagram of another embodiment of a network-enabled auction method.

FIG. 3 is a flow diagram of one embodiment of a price adjusting method.

FIG. 4 is a flow diagram of another embodiment of a price adjusting method.

FIG. 5 is a flow diagram of one embodiment of purchasing via a network-enabled auction method.

FIG. 6 is a block diagram of one embodiment of a network-enabled auction system.

FIG. 7 is a block diagram of another embodiment of a network-enabled auction system.

FIG. 8 is a simplified block diagram of one embodiment of a secure transaction system with network-enabled auction capabilities.

FIG. 9 is a simplified block diagram of one embodiment of a privacy card for a personal transaction device for use in connection with a network-enabled auction system.

FIG. 10 is a simplified block diagram of one embodiment of a digital wallet for a personal transaction device for use in connection with a network-enabled auction system.

### DETAILED DESCRIPTION

Limited inventory is offered for sale at iteratively adjusted pricing. An item of an inventory is offered for sale to a consumer at a current sale price in a network-enabled auction. The current sale price for the item is iteratively adjusted based upon pre-defined criteria. A bid on the item is received from the consumer at the current sale price. Since the auction may be a “forward” auction, a detailed description may be provided to a potential consumer. In a “forward” auction, a seller first offers a particular item and then buyers can bid on the item. Thus, the buyer may be made aware of details relating to the item. Additionally, the buyer may know that his bid will be accepted at the time of making it.

The term “bid” means the price that a buyer offers to pay for a good or service as a noun, or the act of placing such a bid as a verb. The term “inventory” refers to the quantity of goods or services on hand. The terms “stock” and “inventory” will be used interchangeably. The term “item” will be used interchangeably with the term “good” and the term “service”. The terms “current sale price” and “current price” will be used interchangeably. The terms “buyer” and “consumer” will be used interchangeably. The term “auction service” is used interchangeably with the term “auction”.

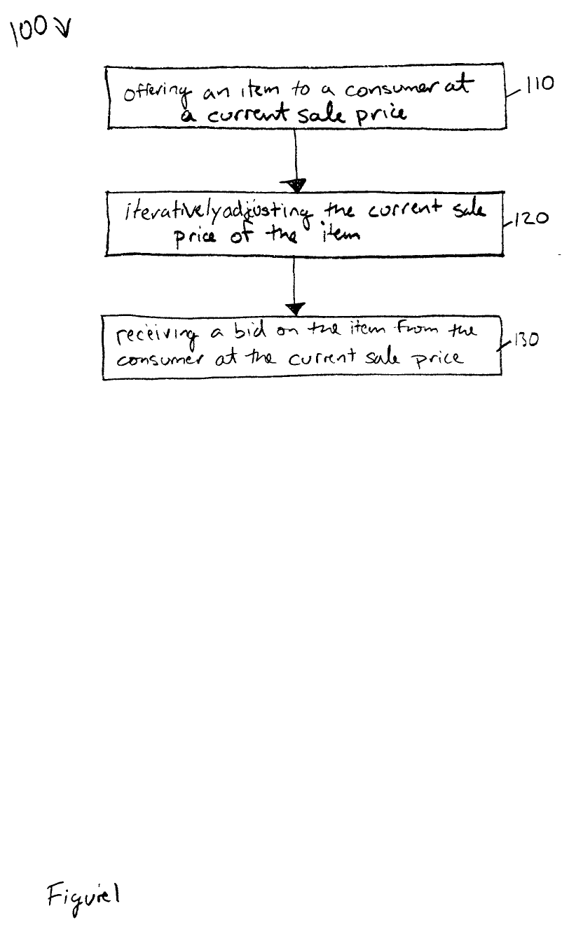

FIG. 1 is a flow diagram of one embodiment of a network-enabled auction method executed by a server such as server 610 in FIG. 6. At block 110, an item is offered to a consumer at a current sale price. At block 120, the current sale price of the item is iteratively adjusted. In one embodiment the item is initially offered at a relatively high current sale price. With time and the continued availability of stock of the item, the initial price may be iteratively adjusted to provide a series of current sale prices.

In one embodiment, the auction is Internet-enabled. In another embodiment, the price adjustment is to reduce the current sale price. In yet another embodiment, the price adjustment is to increase the current sale price. In still another embodiment, the price adjustment is based upon a market index. In still another embodiment, the market index may be a duration of time that has passed since the item was first offered at the current sale price or a total quantity of inventory remaining. At block 130, a bid is received on the item from the consumer at the current sale price.

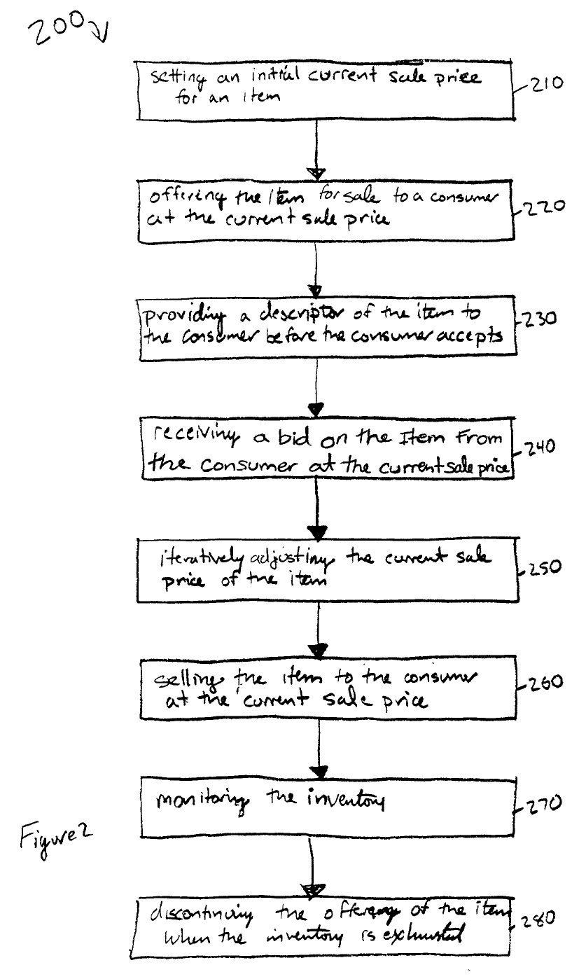

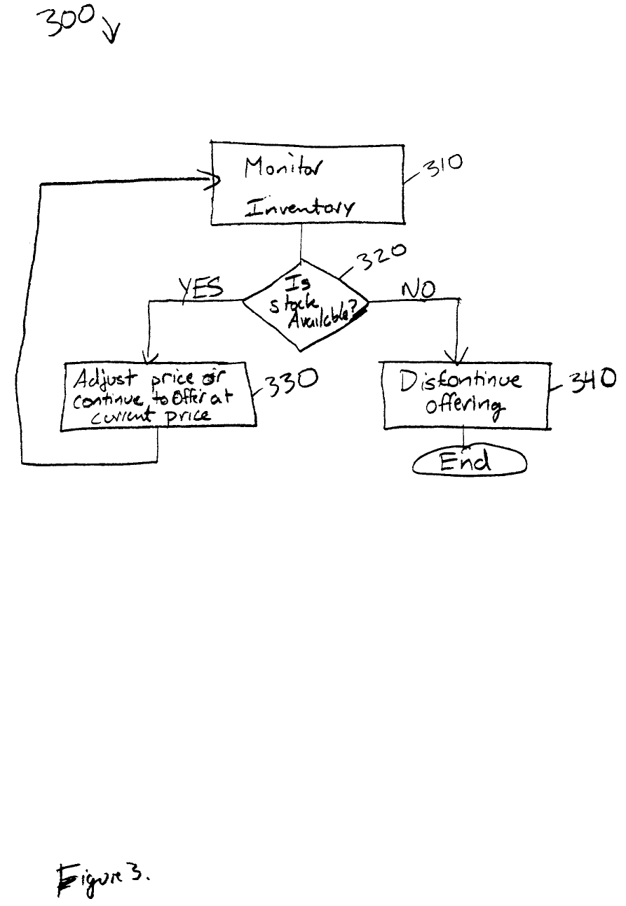

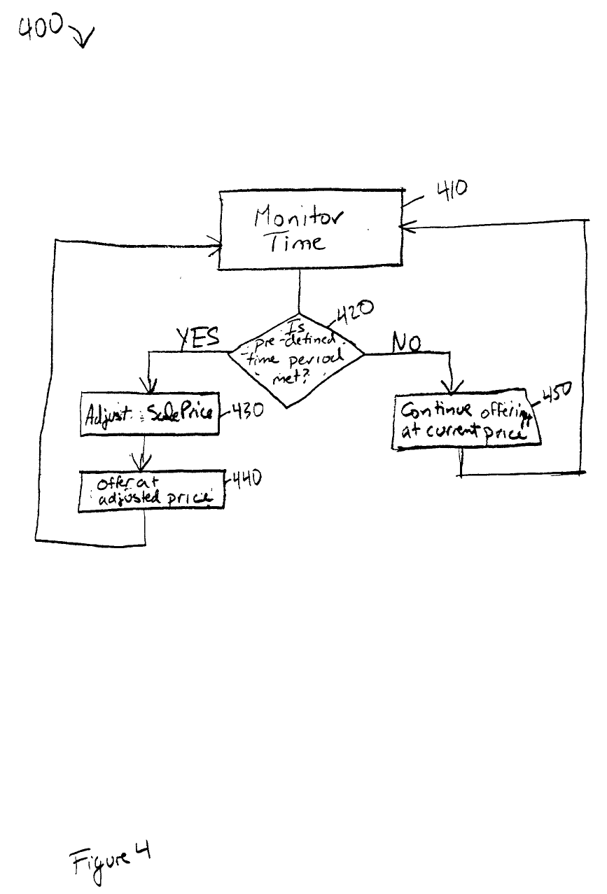

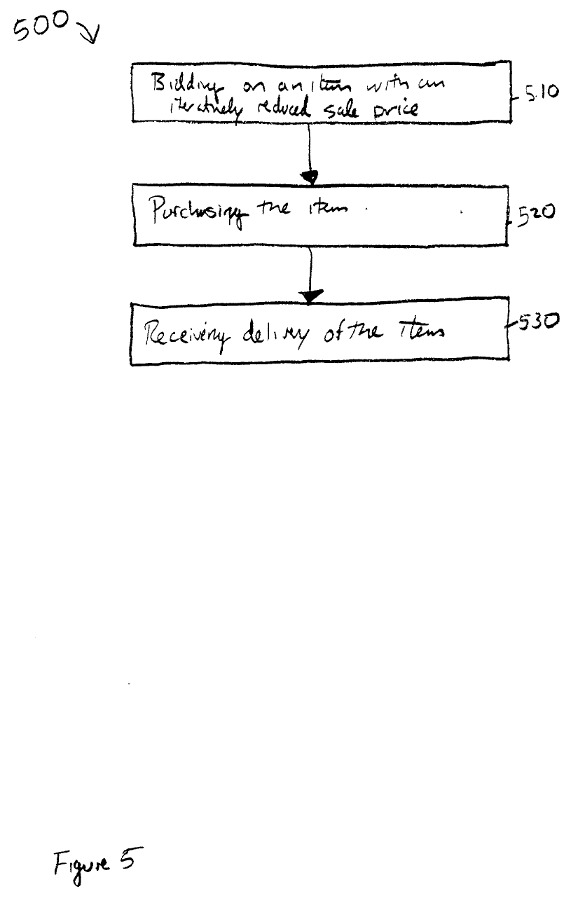

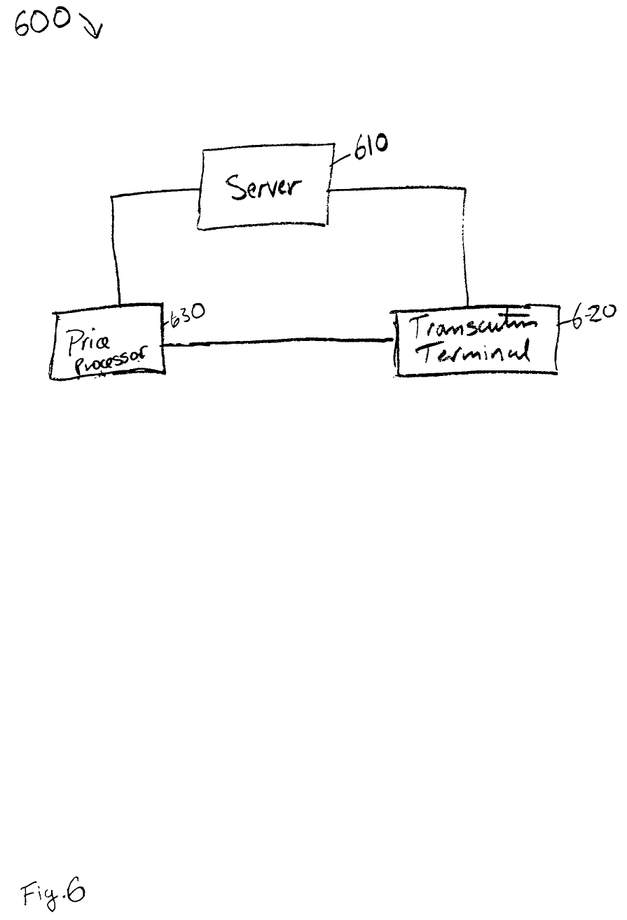

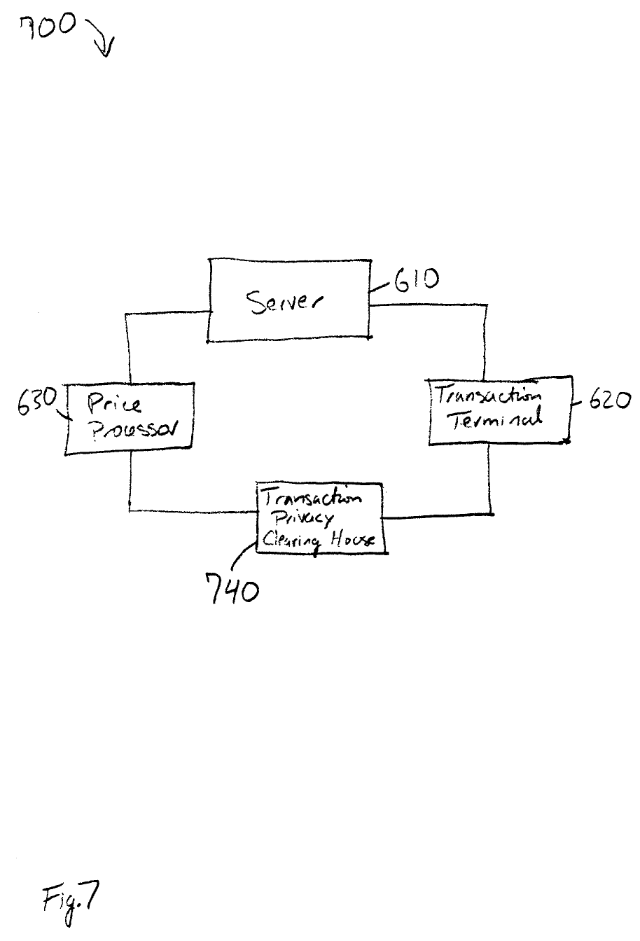

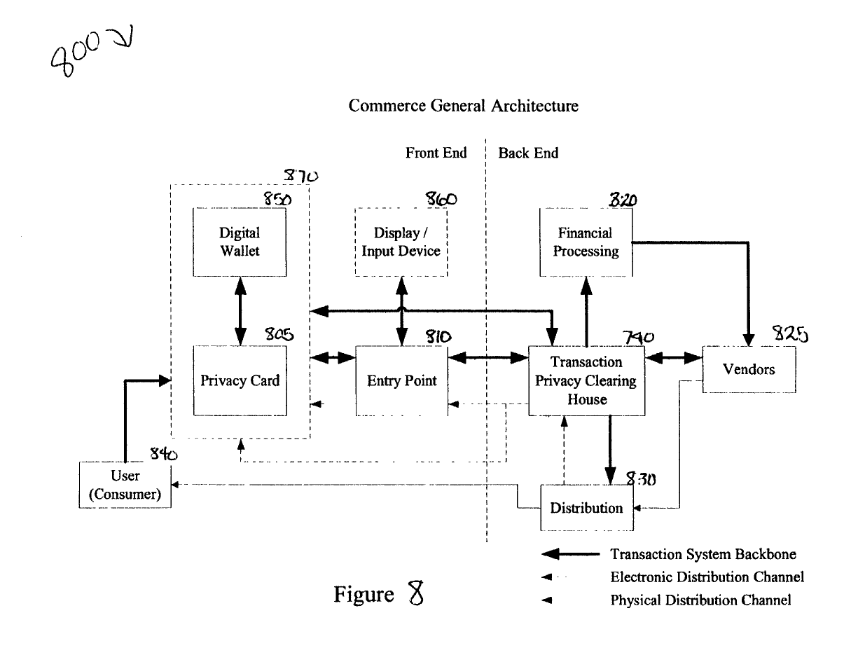

FIG. 2 is a flow diagram of another embodiment of a network-enabled auction method. At block 210, an initial current sale price is set for an item. At block 220, the item is offered for sale to a consumer at the current sale price. At block 230, a descriptor of the item is provided to the consumer before the consumer accepts the offering of the item. At block 240, a bid is received on the item from the consumer at the current sale price. The bid may indicate the consumer's willingness to purchase the item at the current sale price. In one embodiment, all bids are accepted if they are made at the current sale price. At block 250, the current sale price of the item is iteratively adjusted. In one embodiment, the iterative adjustment is based upon continued availability of stock, as described below in conjunction with FIG. 3. In another embodiment, the iterative adjustment is based upon the passage of a pre-defined period of time, as described below in conjunction with FIG. 4. At block 260, the item is sold to the consumer at the current sale price. At block 270, the inventory is monitored. In another embodiment, the duration of time that has passed since the item was first offered at the current sale price is monitored. Information related to the monitoring of inventory, duration of time of offering, or other measurement may be used to calculate or refine the current sale price. At block 280, the offering of the item is discontinued when the inventory is exhausted. In one embodiment, a potential buyer is provided with one or more descriptors to describe the item in detail. For example, if the offering is airline tickets, the descriptor may be a current sale price of the item, an airline name, an airline flight class, a number of seats available, a departure city, a departure time, a destination city, an arrival time, or a flight date. The auction service might make available five economy class seats on Continental Airlines™ flight 493 traveling from Newark, N.J. to Las Vegas, Nev. at 11:00 am on Oct. 11, 2001 and a similarly specific return flight. At some time prior to the flight, i.e. one week before the flight, the auction service could make available the 5 tickets. The sale could begin at 12:00 pm and an initial current sale price of $225 could be posted. When inventory decreases to a pre-defined quantity, the auction service may notify the consumer of inventory status to provide an additional incentive for to consumer to make his bid so that the consumer will not be left out. (Continental Airlines™ is a registered trademark of Continental Airlines, Inc.).

In one embodiment, where there is a simultaneous bid for the last remaining item of inventory there may be a resultant dissatisfaction for one of the bidding parties due to the fact that he has accepted the offering of the item at the current sale price but is not able to receive the item because the inventory has been exhausted. An incentive may offered to the dissatisfied party to participate in a future sale of another item.

In another embodiment, the buyer may be immediately notified that his bid has been accepted. In yet another embodiment, the consumer receives delivery of the item.

FIG. 3 is a flow diagram of one embodiment of a price adjusting method. At block 310 stock inventory is monitored. This monitoring may be the same as or different from the monitoring in block 270 of FIG. 2. At block 320, a determination is made whether stock is still available. If stock is still available, at block 330, the price is adjusted and the item is offered at the adjusted price, or the item continues to be offered at the current price. The adjusted price may be a lower price or a higher price. The process returns to block 310 for ongoing monitoring. At block 340, the offering of the item is discontinued if no stock is available.

FIG. 4 is a flow diagram of another embodiment of a price adjusting method. At block 410, the time since the product was first offered at the current sale price is monitored. At block 420, a determination is made of whether the time that has passed meets a pre-defined price adjustment time period. At block 430, the sale price is adjusted if the time that has passed is greater than the time period. At block 440, the item is offered at the adjusted price. The process returns to block 410 for additional monitoring. At block 450, if the time that has passed is less than the pre-defined time period, the item continues to be offered at the current price.

To illustrate FIGS. 4 and 5, the following example is provided. In an auction for airplane tickets, as in the example presented in FIG. 2 above, if five seats were initially offered and continue to be available after the price adjustment time period without any bids being made, a dollar percentage may be deducted from the current sale price. Thus, for example, a ticket initially offered at a current sale price of $225 at 12:00 p.m. might, at 2:30 p.m. the same day, be reduced by ten percent to a current sale price of $202.50. In one embodiment, the auction may continue to iteratively lower the current sale price of the ticket price until the inventory is exhausted. The auction service may sell a variety of types of items in addition to airline tickets including, for example, household goods, automobiles, electronic goods and sporting equipment, but the invention is not so limited.

FIG. 5 is a flow diagram of an embodiment of purchasing via a network-enabled auction method. At block 510, a bid is placed for an item with an iteratively adjusted sale price. At block 520, the item is purchased. At block 530 delivery of the item is received. In one embodiment, the consumer places his bid using a personal transaction device (PTD) to ensure privacy of the transaction. In another embodiment, the consumer purchases the item using the PTD.

FIG. 6 is a block diagram of one embodiment of a network-enabled auction system. In FIGS. 6-10, like numbered blocked indicate similar components having similar functions. Server 610 offers items for sale on the network-enabled auction and iteratively adjusts the price of the item, based upon instructions from a vendor. Server 610 may be coupled to transaction terminal 620 and price processor 630. Price processor 630 may be referred to as a “smart engine” or a “price engine.” In one embodiment, transaction terminal 620 may be a personal computer, a personal transaction device (PTD), or a PTD coupled to a transaction privacy clearing house, as discussed below. In one embodiment, price processor 630 is a component of server 610. Transaction terminal 620 receives a bid from a consumer for the item. Transaction terminal 620 communicates the bid to server 610. Server 610 may authorize the transaction. The authorization may be based upon a consumer credit rating, prior transactions with the consumer or other factors. In one embodiment, if the transaction is not authorized, the process terminates. Price processor 630 can provide price instructions from the vendor to server 610 by calculating a new price for the item. The calculation of the new price may be based upon a market index. The market index may be a total quantity of inventory remaining, a duration of time that has passed since the item was first offered for sale at the current sale price or another type of index. In another embodiment, server 610 or an inventory monitoring device (“monitor”) coupled to server 610 directly monitors the inventory of the stock. Server 610 may store an identification to track the available inventory. Server 610 also may complete transactions and manage inventory. In one embodiment, the buyer knows the inventory quantity. Although the auction service described may offer the goods to the consumer, possess the goods and provide them to the consumer, alternate embodiments in which a third party is involved to warehouse and provide the goods to the consumer are also contemplated.

FIG. 7 is a block diagram of an alternate embodiment of a network-enabled auction system. Transaction privacy clearing house (TPCH) 740 enables transactions to be performed without revealing the identity of the consumer.

FIG. 8 is a simplified block diagram of one embodiment of a secure transaction system with network-enabled auction capabilities, which may be used in electronic commerce. In this embodiment, a transaction privacy clearing house (TPCH) 740 interfaces a user (consumer) 840 and a vendor 825. In this particular embodiment, a personal transaction device (PTD) 870, e.g., a privacy card 805, or a privacy card 805 coupled to a digital wallet 850, is used to maintain the privacy of the user while enabling the user to perform transactions. In an alternate embodiment, the PTD 870 may be any suitable device that allows unrestricted access to TPCH 740. The personal transaction device information is provided to the TPCH 740 that then indicates to the vendor 825 and the user 840 approval of the transaction to be performed.

In order to maintain confidentiality of the identity of the user 840, the transaction device information does not provide user identification information. Thus, the vendor 825 or other entities do not have user information but rather transaction device information. The TPCH 740 maintains a secure database of transaction device information and user information. In one embodiment, the TPCH 740 interfaces to at least one financial processing system 820 to perform associated financial transactions, such as confirming sufficient funds to perform the transaction, and transfers to the vendor 825 the fees required to complete the transaction. In addition, the TPCH 740 may also provide information through a distribution system 830 that, in one embodiment, can provide a purchased product to the user 840, again without the vendor 825 knowing the identification of the user 840. In an alternate embodiment, the financial processing system 820 need not be a separate entity but may be incorporated with other functionality. For example, in one embodiment, the financial processing system 820 may be combined with the TPCH 740 functionality.

In one embodiment, the financial processing system (FP) 820 performs tasks of transferring funds between the user's account and the vendor's account for each transaction. In one embodiment, the presence of the TPCH 740 means that no details of the transactions, other than the amount of the transactions and other basic information, are known to the FP 820. The TPCH 815 issues transaction authorizations to the FP 820 function on an anonymous basis on behalf of the user over a highly secure channel. The FP 820 does not need to have many electronic channels receiving requests for fund transfer, as in a traditional financial processing system. In one embodiment, a highly secure channel is set up between the TPCH 740 and the FP 820; thus, the FP 820 is less vulnerable to spoofing.

In one embodiment, the FP 820 is contacted by the TPCH 740 requesting a generic credit approval of a particular account. Thus, the FP 820 receives a minimal amount of information. In one embodiment, the transaction information, including the identification of goods being purchased with the credit need not be passed to the FP 820. The TPCH 740 can request the credit using a dummy charge ID that can be listed in the monthly credit statement sent to the user, so that the user can reconcile his credit statement. Further, the personal transaction device 805 can include functionality to cause the credit statement to convert the dummy charge ID back to the transactional information so that the credit statement appears to be a conventional statement that lists the goods that were purchased and the associated amount charged.

A display input device 860 (shown in phantom) may be included to enable the user, or in some embodiments the vendor 825, to display status and provide input regarding the PTD 805 and the status of the transaction to be performed.

In yet another embodiment, an entry point 810 interfaces with the personal transaction device 870 and also communicates with the TPCH 740. The entry point 810 may be an existing (referred to herein as a legacy POS terminal) or a newly configured point of sale (POS) terminal located in a retail environment. The user 840 uses the PTD 870 to interface to the POS terminal in a manner similar to how credit cards and debit cards interface with POS terminals. The entry point 810 may also be a public kiosk, a personal computer, or the like.

The system described herein also provides a distribution functionality 830 whereby products purchased via the system are distributed. In one embodiment, the distribution function 830 is integrated with the TPCH 740 functionality. In an alternate embodiment, the distribution function 830 may be handled by a third party. Utilizing either approach, the system ensures user privacy and data security. The distribution function 830 interacts with the user through PTD 830 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 870 to change the shipping address of the product at any time during the distribution cycle.

An auction server may be coupled to entry point 810 and TPCH 740 to enable the auction services to be provided to the user.

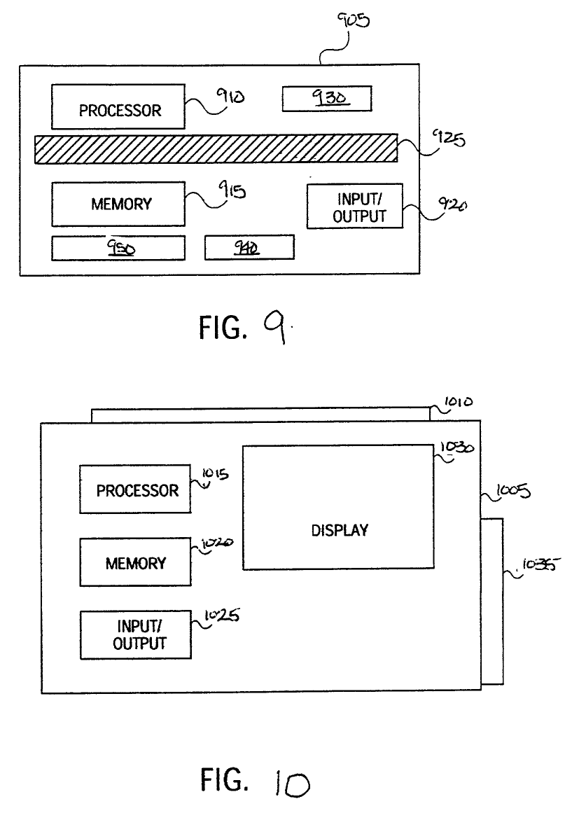

FIG. 9 is a simplified block diagram of one embodiment of a privacy card for a personal transaction device for use in connection with a network-enabled auction system. A user connects to and performs transactions with a secure transaction system (such as shown in FIG. 8) through a personal transaction device (PTD) that has a unique identifier (ID). In one embodiment, a privacy card is used. In an alternate embodiment, a digital wallet is used. In yet another alternate embodiment, a privacy card in conjunction with a digital wallet is used.

One embodiment of a privacy card 905 is illustrated in FIG. 8. In one embodiment, the card 905 is configured to be the size of a credit card. The privacy card includes a processor 910, memory 915 and input/output logic 930. The processor 910 is configured to execute instructions to perform the functionality herein. The instructions may be stored in the memory 915. The memory is also configured to store data, such as transaction data and the like. In one embodiment, the memory 915 stores the transaction ID used to perform transactions in accordance with the teachings of the present invention. Alternately, the processor may be replaced with specially configured logic to perform the functions described here.

The input/output logic 930 is configured to enable the privacy card 905 to send and receive information. In one embodiment, the input/output logic 930 is configured to communicate through a wired or contact connection. In another embodiment, the logic 930 is configured to communicate through a wireless or contactless connection. A variety of communication technologies may be used.

In one embodiment, a display 925 is used to generate bar codes scan able by coupled devices and used to perform processes as described herein. The privacy card 905 may also include a magnetic stripe generator 940 to simulate a magnetic stripe readable by devices such as legacy POS terminals.

In one embodiment, biometric information, such as fingerprint recognition, is used as a security mechanism that limits access to the card 905 to authorized users. A fingerprint touch pad and associated logic 930 is therefore included in one embodiment to perform these functions. Alternately, security may be achieved using a smart card chip interface 950, which uses known smart card technology to perform the function.

Memory 915 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 915 can also have user identity/account information block. The user identity/account information block stores data about the user and accounts that are accessed by the card. The type of data stored includes the Meta account information used to identify the account to be used.

Bidding and other transactions related to the network-enable auction can be performed with a personal transaction device, such as privacy card 905.

FIG. 10 is a simplified block diagram of one embodiment of a digital wallet for a personal transaction device for use in connection with a network-enabled auction system.

One embodiment of a digital wallet 1005 is illustrated in FIG. 10. The digital wallet 1005 includes a coupling input 1010 for the privacy card 905, processor 1015, memory 1020, input/output logic 1025, display 1030 and peripheral port 1035. The processor 1015 is configured to execute instructions, such as those stored in memory 1020, to perform the functionality described herein. Memory 1020 may also store data including financial information, eCoupons, shopping lists and the like. The digital wallet may be configured to have additional storage. In one embodiment, the additional storage is in a form of a card that couples to the device through peripheral port 1010.

In one embodiment, the privacy card 905 couples to the digital wallet 1005 through port 1010; however, the privacy card 905 may also couple to the digital wallet 1005 through another form of connection including a wireless connection.

Input/output logic 1025 provides the mechanism for the digital wallet 1005 to communicate information. In one embodiment, the input/output logic 1025 provides data to a point-of-sale terminal or to the privacy card 905 in a pre-specified format. The data may be output through a wired or wireless connection.

The digital wallet 1005 may also include a display 1030 for display of status information to the user. The display 1030 may also provide requests for input and may be a touch sensitive display, enabling the user to provide the input through the display.

The physical manifestation of many of the technologies in the digital wallet 1005 will likely be different from those in the privacy card 905, mainly because of the availability of physical real estate in which to package technology. Examples of different physical representations would include the display, fingerprint recognition unit, etc.

Bidding and other transactions related to the network-enable auction can be performed with a personal transaction device, such as digital wallet 1005.

The components of a secure transaction system illustrated in FIGS. 8, 9, and 10 are further described in PCT published patent application number US 00/35619, which is assigned to the same assignee as the present application and which is hereby incorporated by reference.

It will be further appreciated that the instructions represented by the blocks in FIGS. 1-5 are not required to be performed in the order illustrated, and that all the processing represented by the blocks may not be necessary to practice the invention.

It will be appreciated that the methods described in conjunction with FIGS. 1-5 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
offering an item of an inventory for sale to a consumer at a current sale price in a network-enabled auction;
iteratively adjusting the current sale price for the item based upon pre-defined criteria; and
receiving a bid on the item from the consumer at the current sale price.

2. The method of claim 1, further comprising setting an initial current sale price.

3. The method of claim 1, further comprising providing an incentive to the consumer to participate in a future sale when the item is unavailable.

4. The method of claim 1, further comprising offering an incentive to the consumer to purchase the item when the inventory is nearly exhausted.

5. The method of claim 1, further comprising providing a descriptor of the item to the consumer before the consumer accepts the offering of the item at the current sale price.

6. The method of claim 1, further comprising:
selling the item to the consumer at the current sale price.

7. The method of claim 1, wherein the adjusting is selected from the group consisting of:
reducing the current sale price; and
increasing the current sale price.

8. The method of claim 1, wherein the pre-defined criteria is a market index.

9. The method of claim 8, wherein the market index comprises a duration of time that has passed since the item was first offered for sale at the current sale price.

10. The method of claim 8, wherein the market index further comprises a total quantity of the inventory remaining.

11. The method of claim 1, further comprising discontinuing the offering of the item when the inventory is exhausted.

12. A machine-readable medium having stored thereon a plurality of instructions, when executed by a machine, cause the machine to perform a method comprising:
offering an item of an inventory for sale to a consumer at a current sale price in a network-enabled auction;
iteratively adjusting the current sale price for the item based upon pre-defined criteria; and
receiving a bid on the item from the consumer at the current sale price.

13. The machine-readable medium of claim 12, wherein the method further comprises discontinuing the offering of the item when the inventory is exhausted.

14. The machine-readable medium of claim 12, wherein the pre-defined criteria is a total quantity of the inventory remaining.

15. The machine-readable medium of claim 12, wherein the pre-defined criteria is a duration of time that has passed since the item was first offered for sale at the current sale price.

16. An apparatus comprising a server to iteratively adjust a price for an item of an inventory offered for sale in a network-enabled auction based upon instructions from a vendor.

17. The apparatus of claim 16, further comprising a transaction terminal communicatively coupled to the server to receive a bid from a consumer for the item and to communicate the bid to the server.

18. The apparatus of claim 16, wherein the transaction terminal is selected from the group consisting of:
a personal computer;
a personal transaction device (PTD); and
a personal transaction device coupled to a transaction privacy clearing house (TPCH).

19. A system comprising:
a processing unit;
a memory coupled to the processing unit through a bus; and
a network-enabled auction service executed from the memory by the processing unit to offer an item of inventory to a consumer at a current sale price, the current sale price being iteratively adjusted until the inventory is exhausted, and to receive a bid on the item at the current sale price.

20. The system of claim 19, wherein the current sale price is iteratively adjusted based upon a duration of time that has passed since the item was first offered for sale at the current sale price.

21. The system of claim 19, wherein the current sale price is iteratively adjusted based upon a total quantity of inventory remaining.
